(19) United States
(12) Patent Application Publication
(10) Pub. No.: US 2025/0166586 A1
(43) Pub. Date: May 22, 2025

(54) METHOD, APPARATUS, DEVICE AND STORAGE MEDIUM FOR INFORMATION DISPLAY

(71) Applicant: Beijing Zitiao Network Technology Co., Ltd., Beijing (CN)

(72) Inventors: Anning ZOU, Beijing (CN); Wangpeng ZHOU, Beijing (CN)

(21) Appl. No.: 18/954,254

(22) Filed: Nov. 20, 2024

(30) Foreign Application Priority Data
Nov. 22, 2023 (CN) 202311569080.8

(51) Int. Cl. G09G 5/22; H04L 43/106

(52) U.S. Cl. CPC G09G 5/22; H04L 43/106; G09G 2370/02

(57) ABSTRACT

There are provided a method, an apparatus, a device and a storage medium for information display. In the method, a reception interval of characters is determined based on a received first data packet comprising at least one character, wherein the reception interval indicates a first time duration consumed by receiving a single character. A reference display interval for characters to be displayed in the first data packet is determined based on the reception interval and the number of the characters to be displayed, wherein the reference display interval indicates a second time duration consumed for displaying a single character. Further, at least a portion of the characters to be displayed is displayed based on the reference display interval. Therefore, the smoothness of information display can be improved, and the user experience is improved.

### CROSS-REFERENCE

The present application claims priority to Chinese Patent Application No. 202311569080.8, filed on Nov. 22, 2023, and entitled “METHOD, APPARATUS, DEVICE AND STORAGE MEDIUM FOR INFORMATION DISPLAY”, the entirety of which is incorporated herein by reference.

### FIELD

Example embodiments of the present disclosure generally relate to the field of computers, and in particular, to a method, an apparatus, a device, and a computer-readable storage medium for information display.

### BACKGROUND

With the development of information technologies, various terminal devices may provide various services to people in terms of work and life. For example, an application providing a service may be deployed in the terminal device. The terminal device or an application thereof may provide an assistant-like function to the user, to assist the user in completing the target task by using the terminal device or the application. How to make such an assistant-like function better serve the user is a currently exploring technical problem.

### SUMMARY

In a first aspect of the present disclosure, a method of information display is provided. The method comprises: determining a reception interval of characters based on a received first data packet comprising at least one character, the reception interval indicating a time duration consumed by receiving a single character; determining a reference display interval for characters to be displayed in the first data packet based on the reception interval and the number of characters to be displayed, the reference display interval indicating a time duration consumed for displaying a single character; and displaying at least a portion of the characters to be displayed based on the reference display interval.

In a second aspect of this disclosure, an apparatus for displaying information is provided. The apparatus comprises: a reception interval determining module configured to determine a reception interval of characters based on a received first data packet comprising at least one character, the reception interval indicating a time duration consumed by receiving a single character; a reference display interval determining module configured to determine a reference display interval for characters to be displayed in the first data packet based on the reception interval and the number of characters to be displayed, the reference display interval indicating a time duration consumed for displaying a single character; and a character displaying module configured to display at least a portion of the characters to be displayed based on the reference display interval.

In a third aspect of this disclosure, an electronic device is provided. The device comprises: at least one processing unit; and at least one memory coupled to the at least one processing unit and storing instructions for execution by the at least one processing unit, the instructions, when executed by the at least one processing unit, causing the device to perform the method according to the first aspect.

In a fourth aspect of this disclosure, a computer-readable storage medium is provided. The computer-readable storage medium has stored thereon a computer program executable by a processor to implement the method according to the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF THE DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A and 2B show schematic diagrams of differences between character output in an ideal situation and actual user reception;

FIG. 3 shows a flowchart of a method of information display according to some embodiments of the present disclosure;

FIG. 4 shows a schematic diagram of an adjustment item that varies with the number of characters to be displayed according to some embodiments of the present disclosure;

FIG. 5 shows a flowchart of an example process of information display according to some embodiments of the present disclosure;

FIG. 6 shows a schematic structural block diagram of an apparatus for displaying information according to some embodiments of the present disclosure; and

FIG. 7 shows a block diagram illustrating an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for illustrative purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, one step being performed “responding to A” does not imply that this step is performed immediately after “A”, but may include one or more intermediate steps.

It may be understood that the data involved in the technical solution (including but not limited to the data itself, the obtaining, using, storing or deleting of the data) should comply with the requirements of the corresponding laws and regulations and related regulations.

It can be understood that before using the technical solutions disclosed in the embodiments of the present disclosure, relevant users should be informed of the types, use ranges, usage scenarios, and the like of the information related to the present disclosure in an appropriate manner according to relevant laws and regulations, and the authorization of the related users may be obtained, wherein the relevant users may include any type of rights body, such as individuals, businesses, and groups.

For example, when a user's active request is received, a prompt message is sent to the user to explicitly prompt the user that an operation requested by the user will require the acquisition and use of the user's personal information. Thereby, the user can independently choose whether to provide personal information to the software or hardware (such as an electronic device, an application program, a server, or a storage medium) that executes the operation of the technical solution of the present disclosure according to the prompt message.

As an optional but non-restrictive implementation, the manner of sending the prompt message to the user in response to receiving the active request from the user may be, for example, a pop-up window, and the prompt message may be presented in text in the pop-up window. In addition, the pop-up window may also carry a selection control for the user to select “agree” or “disagree” to provide personal information to the electronic device.

It should be understood that the above notification and user authorization acquisition process are merely illustrative and do not limit the implementations of the present disclosure. Other manners that meet relevant laws and regulations may also be applied to the implementations of the present disclosure.

As used herein, the term “character” refers to a glyph unit or symbol, including but not limited to letters, words, numbers, arithmetic symbols, punctuation symbols, and other symbols. For example, a character may be a Chinese character, an English letter, an Arabic numeral, a punctuation mark, a graphic symbol or a control symbol, and the like.

As used herein, the term “packet” refers to a logical transport unit that includes at least one character. A packet is sometimes referred to herein simply as “data”.

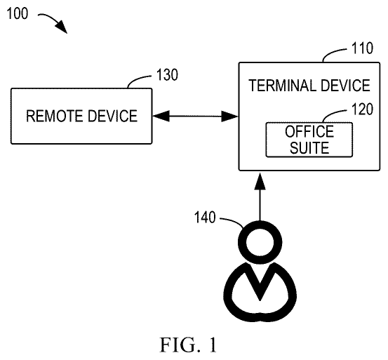

FIG. 1 illustrates a schematic diagram of an example environment 100 in which embodiments of the present disclosure can be implemented. In this example environment 100, an office suite 120 is installed in the terminal device 110. The user 140 may interact with the office suite 120 via the terminal device 110 and/or an attachment device of the terminal device 110. The office suite 120 can provide integration of multiple components to the user 140. These components may serve as component modules in the office suite 120. Components integrated in the office suite 120 are sometimes referred to as “office applications”, “office components”, “collaborative working platforms”, and the like. As an example, components integrated in the office suite 120 may include, but are not limited to, one or more of: a chat component (also referred to as an instant messaging (IM) component), a document component, an audio-video conference component, a mail component, a calendar component, a schedule component, a task component, an objective and key result (OKR) component.

In some embodiments, the office suite 120 may be downloaded as an application, installed on the terminal device 110. In some embodiments, the office suite 120 may also be accessed in other manners, such as web page access.

In some embodiments, the terminal device 110 communicates with a remote device 130 to enable provision of services to the office suite 120. The terminal device 110 may be any type of mobile terminal, fixed terminal, or portable terminal, including a mobile phone, a desktop computer, a laptop computer, a notebook computer, a netbook computer, a tablet, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The remote devices 130 may be various types of computing systems/servers capable of providing computing power, such as computing systems/servers of office suite 120, including, but not limited to, mainframes, edge computing nodes, computing devices in a cloud environment, and so forth.

The office suite 120 may provide a digital assistant to the user 140. The user 140 and the digital assistant may assist the user 140 in using the office suite 120 in a dialog. In some embodiments, in order to provide a reply to the user 140, the remote device 130 may utilize a machine learning model. The remote device 130 sends a reply of the digital assistant to the user interaction message to the terminal device 110 through the network, and the terminal device 110 presents the reply to the user 140.

It should be understood that the structures and functions of the various elements in the environment 100 are described for illustrative purposes only and do not imply any limitation to the scope of the present disclosure. For example, embodiments of the present disclosure may be applied to any suitable one or more applications, not limited to office suites.

Some example machine learning models that the remote device 130 may utilize are illustrated below.

In some examples, the machine learning model may be a dialog generation model. The dialog generation model is a type of artificial intelligence model that may be used to generate a natural language dialog, and is intended to simulate human dialog capabilities. The dialog generation model can understand the user's input and generate relevant replies.

In some embodiments, the dialog generation model may be a rule-based dialog system. The rule-based dialog system may respond to the user's input by using predefined rules and/or templates. The rules may be based on matched keyword, or grammar and context. An advantage of such rules-based dialog systems is that they are easy to be built and adjusted, but the drawback is poor performance for complex dialog tasks because they cannot handle with the flexible linguistic expressions and semantic understanding.

Alternatively or additionally, the dialog generation model may be a retrieval dialog system. The retrieval dialog system responds to the user by looking up the most matched reply in the predefined dialog database based on the retrieval technique. The dialog database of the system may be composed of manually written dialog samples, or may be extracted from large-scale dialog data. An advantage of the retrieval dialog system is that the accuracy of the reply is high, but the disadvantage is that a reasonable response is difficult for the unseen problem or the problem without context.

Alternatively or additionally, the dialog generation model may be a sequence-to-sequence (seq2seq) based dialog system. Such dialog systems use an encoder-decoder architecture in which an encoder encodes a user input into a fixed-length vector representation, and a decoder decodes the vector representation into a reply. Such models typically use recurrent neural networks (RNNs) or Transformers as basic modules. The model can handle input and output sequences of different lengths, and can generate more flexible and semantically rich replies than simple rule systems.

Alternatively or additionally, the dialog generation model may be an attention mechanism based dialog system. The attention mechanism based dialog system introduces an attention mechanism on a sequence-to-sequence based dialog system, in order to better handle long sequences and context dependencies. The attention mechanism allows the model to assign different attention weights to different portions of the encoder during decoding, thereby better capturing relevant information of the input. This model performs well when generating a long dialog and can handle complex context dependencies.

Alternatively or additionally, the dialog generation model may be a dialog system based on a pre-trained language model. Some pre-trained language models have better effects in dialog generation tasks. These models can be pre-trained using large-scale text data, thereby having rich language knowledge. The model can generate coherent and meaningful dialog replies by performing fine tuning on the dialogue data.

Due to the fact that dialogue generation models typically take some time to generate a complete reply, waiting for the model to output the complete reply before sending it to the user will result in a poor user experience. In some embodiments, the latest generated content may be continuously pushed character by character to the terminal device 110 through streaming data acquisition.

In some embodiments, streaming data acquisition may employ polling. For example, a question may be constantly asked, and an answer is waiting for. In data stream acquisition, a request is continuously sent to a data source during a specified period by polling to check if new data is available. When new data is available, the data source will make feedback. This manner is relatively simple, but requires frequent sending of requests, which may cause waste of resources.

Alternatively or additionally, streaming data acquisition may employ long polling. Long polling is an improved polling approach that works similarly to polling, but remains connected and waits for a period of time when no new data is available, until new data arrives or times out. In this way, unnecessary requests can be reduced, and resources can be saved.

Alternatively or additionally, streaming data acquisition may take the form of WebSockets. WebSockets is a full-duplex communication protocol, allowing a persistent connection between a client and a server, and implementing two-way communication. Unlike polling and long polling, WebSockets allow a server to actively push data to clients without the need for clients to send requests constantly. This approach is suitable for applications requiring high real-time requirements, such as chat applications or real-time data monitoring.

Although the current streaming data acquisition can meet the requirements of data output, no matter what streaming data acquisition manner is used, the output is not smooth enough. For example, in a case where the latest data is obtained by periodically sending a request by polling, there is a certain interval between each data acquisition, which will result in a certain interval between each output. In addition, due to factors such as network instability and the like, the acquisition of data streams is often not smooth and uniform.

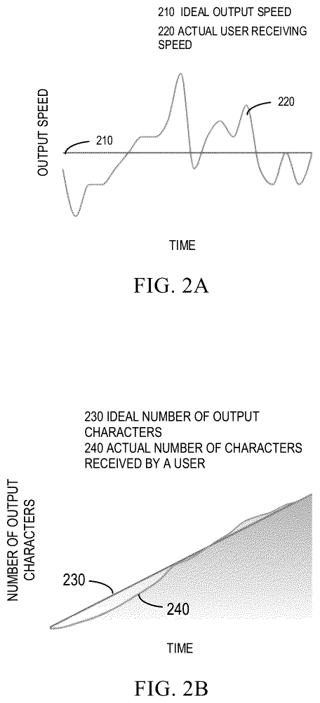

FIGS. 2A and 2B illustrate schematic diagrams of differences between character output in ideal situation and actual user reception of a machine learning model. As shown in FIG. 2A, the output speed 210 of the reply of model in the ideal situation may be represented as a horizontal straight line, that is, it indicates that the output speed of the reply of model is consistent. However, the actual speed at which the user receives a reply from the model may be fluctuating, with a large difference from the ideal situation.

As shown in FIG. 2B, the number of output characters 230 of the replies of model in ideal situation is increased uniformly over time. However, the actual number of characters of the replies received by the user from the model is difficult to increase uniformly at a constant speed over time. If the replies are displayed to the user according to the actual situation, the visual effect presented by the replies received by the user will be unsmooth, for example, such as sometimes fast, sometimes slow, or jammed, which will reduce the user's experience. In some cases, if the output speed of the model is too fast, for example, which exceeds the refresh rate of the display device in the terminal device used by the user, unnecessary overheads are generated. For example, the refresh rate of the display used by most users is 60 Hz, and when the data output speed of the model is too fast (for example, greater than 60 Hz), the rendering of the data is still triggered. However, due to limitations of the display refresh rate, the rendered content cannot be all rendered, resulting in unnecessary overhead.

Therefore, embodiments of the present disclosure provide a solution for information display. According to various embodiments of the present disclosure, the terminal device 110 determining a reception interval of characters based on a received first data packet comprising at least one character, wherein the reception interval indicates a time duration consumed by receiving a single character. Further, the terminal device 110 determines a reference display interval for characters to be displayed in the first data packet based on the reception interval and the number of characters to be displayed, wherein the reference display interval indicates a time duration consumed for displaying a single character. The terminal device 110 displays at least a portion of the characters to be displayed is based on the reference display interval.

In this way, the degree of smoothness of the information display can be improved, thereby a better experience for the user is provided.

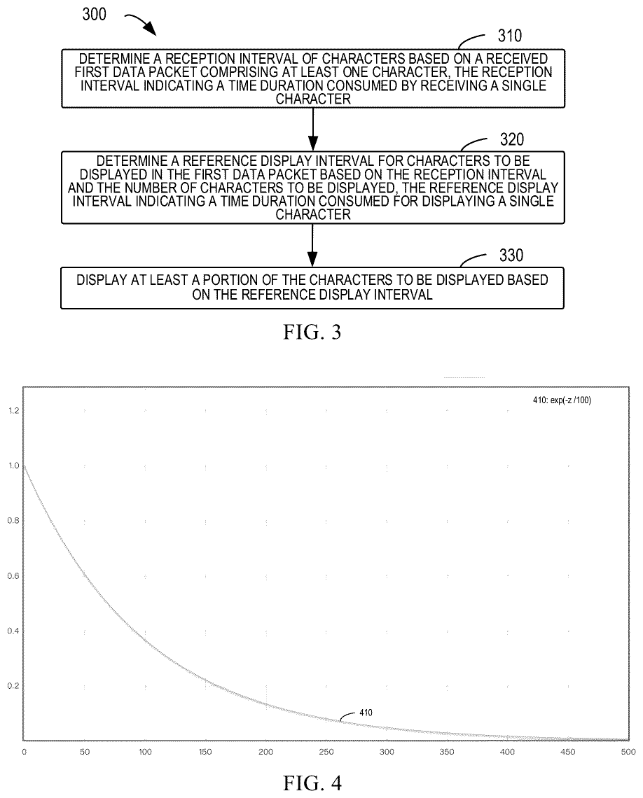

Some example embodiments of the present disclosure are described below with reference to a flowchart. FIG. 3 illustrates a schematic diagram of a method 300 for information display according to some embodiments of the present disclosure. The method 300 may be performed by the terminal device 110 or the office suite 120 in the terminal device 110. For ease of discussion, the method 300 will be described with reference to the environment 100 of FIG. 1.

As shown in FIG. 3, at block 310, the terminal device 110 determines a reception interval of characters based on a received first data packet comprising at least one character, wherein the reception interval indicates a time duration consumed by receiving a single character. In some embodiments, the first data packet may be used as at least a portion of a reply to an interaction message from a user by a digital assistant.

In some embodiments, the terminal device 110 may receive the first data packet from the remote device 130.

Herein, the reception interval is used to indicate a time duration consumed by receiving a single character. In the following description, the reception interval may be represented by k, which may be, for example, in milliseconds. In some embodiments, the reception interval may also be viewed as a time duration consumed to receive a single character, or a reception time interval of two adjacent characters. In some embodiments, each time the terminal device 110 receives a data packet, the time duration (i.e., k) consumed for receiving each character may be calculated according to the time duration consumed for receiving the data packet and the number of characters in the data packet.

In some embodiments, the reception interval of the character is related to the data packet to which it belongs. For example, the reception interval of the character may be determined in the following manner. First, it may be determined whether the first data packet belongs to the first data packet received from the remote device 130 within the target time period. The target time period may be, for example, a predetermined period of time, a time after the terminal device 110 establishes contact with the remote device 130, or the like. For example, the first data packet may indicate the first data packet that the terminal device 110 receives from the remote device 130, after the terminal device 110 establishes contact with the remote device 130.

If the first data packet belongs to the first data packet, the reception interval may be determined based on the reference generation speed of the character. Herein, the reference generation speed may be represented by p, which may be, for example, in milliseconds. In some embodiments, the reference generation speed may be a time duration consumed for the machine learning model to output each character. The reference generation speed may be determined by evaluating the speed of the generated characters of the model. For example, if the model may output 1000 characters in 1 seconds, the reference generation speed may be the time duration consumed to output each character, i.e., p=1 ms. In some embodiments, when the first data packet is the first data packet, the reception interval may be set to be the same as the reference generation speed, that is, k=p. Alternatively, in some embodiments, the reception interval may be set to a value that is close to the reference generation speed.

If the first data packet does not belong to the first data packet, the reception interval may be determined based on the total number of characters received from the remote device 130 in the target time period and the reception time of the first data packet. The total number of characters received may represent the total number of characters that have been received at present. Further, based on the reception time of the first data packet, a time difference between the time of receiving the first data packet and the time when the first data packet is received may be determined. In some embodiments, the reception interval may be the ratio of the total number of characters received to the time difference described above, that is, k=the total number of characters received from the remote device 130 within the target time period/the reception time of the first data packet. Alternatively, in some embodiments, the reception interval may also be the ratio of the total number of received characters to the time difference described above multiplied by a predetermined coefficient.

At block 320, the terminal device 110 determines a reference display interval for characters to be displayed in the first data packet based on the reception interval and the number of characters to be displayed, wherein the reference display interval indicates a time duration consumed for displaying a single character. Further, at block 330, the terminal device 110 displays at least a portion of the characters to be displayed based on the reference display interval.

Next, an example process of how the terminal device 110 determines the reference display interval will be further described.

In some embodiments, the terminal device 110 may determine the reference display interval for the character to be displayed based on the reception interval k and the number of characters to be displayed (which may be represented by z). Herein, the reference display interval may be represented by k′, for example, in milliseconds. The reference display interval may indicate the time duration consumed to display a single character. The number of characters to be displayed may represent the number of characters remaining to be outputted.

In some embodiments, the reference display interval may be determined by:

k′=k×e^{-z/c}

where the adjustment term e^{-z/c} may be considered an adjustment to the reception interval of the character, and c may represent the adjustment parameter. Further, the adjustment parameter c may be a constant, for example, 100.

FIG. 4 shows a schematic diagram of an adjustment item that varies with the number of characters to be displayed according to some embodiments of the present disclosure. Curve 410 shows an adjustment term e^{-z/c} that varies with the number z of characters to be displayed. In this example, c is 100, but this is merely illustrative and not intended to be limiting. As shown in FIG. 4, the larger the number z of characters to be displayed, the smaller the adjustment item. By referring to the formula for the display interval k it can be determined that k′ is directly proportional to the adjustment term e^{-z/c}. Therefore, curve 410 shows the relationship between the reference display interval k′ and the number z of characters to be displayed, that is, the reference display interval increases with the increase of the reception interval and decreases with the increase of the number of characters to be displayed. In this way, the reference display interval may correspondingly change with the reception interval and the number of characters to be displayed, so as to determine the display mode based on the display interval, so that the display is smoother.

As discussed further below, according to some embodiments of the present disclosure, the terminal device 110 may further determine a display mode to optimize a display process of characters in the first data packet.

In some embodiments, the terminal device 110 may determine a current display mode for the character to be displayed at least based on the reference display interval. The current display mode may indicate a duration of a round of character display and a target number of characters displayed in the round of character display (which may be represented by n). Herein, the duration may be represented by m, which may be, for example, in milliseconds. The target number of characters displayed in a round of character display may represent a step size of the model output, that is, how many characters are outputted each time.

In some embodiments, in order to determine the character display mode, the refresh performance of the display device for character display may additionally be considered. Specifically, a time interval between two refreshes of the display device may be determined based on a refresh parameter of the display device for character display. Herein, the refresh parameter may be represented by f, which may be for example in Hz. As an example, the refresh parameter may be, for example, a refresh rate of a display device such as a screen. The time interval between two refreshes may be represented as a ratio of 1000 to refresh parameters, i.e., 1000/f, in milliseconds. For example, one display device with a refresh rate of 60 Hz can refresh 60 frames in 1 seconds, that is, 1 frames occupies 1000÷60≈16.67 (ms), so the time interval between two refreshes of the display device is 16.67 ms.

Next, the terminal device 110 may determine the duration and the target number based on the reference display interval and the time interval. In some embodiments, if the reference display interval exceeds a time interval, the duration is set to a value with a reference display interval, and the target number is set to have a predetermined value. For example, when k′≥(1000/f), m=k′, n=a predetermined value, e.g., 1.

In some embodiments, if the reference display interval is less than the time interval, the duration is set to a value having a time interval. A target number is set based on the duration and the reference display interval. Alternatively, the target number n may be an integer by rounding a ratio of the duration m to the reference display interval k′ For example, if the obtained quotient is not an integer, the quotient may be rounded up or down, and the rounded value is used as the target number. For example, if k′<(1000/f), then m=1000/f, n=round(m/k), where round represents a rounding operation.

In some embodiments, the adjustment parameter c may be updated based on a statistical value of the duration m and a statistical value of the number z of characters to be displayed. In an example, the adjustment parameter c may be set to a reference value initially, and the reference value of the adjustment parameter c may be, for example, 100. In the actual online running of the office suite 120, the adjustment parameters c may be dynamically adjusted by counting the user waiting time and the number of remaining characters to be displayed. Alternatively or additionally, the reference display interval for the character to be displayed may be determined based on the reception interval, the number of characters to be displayed, and the adjustment parameter.

According to an embodiment of the present disclosure, the time interval between two refreshes of the display device is determined by the refresh parameter of the display device, and the time interval between the two refreshes is introduced into the determination of the duration and the target number, thereby adjusting the output speed of the data. Unnecessary overheads caused by rendering of the display device may be avoided.

In some embodiments, the terminal device 110 may display at least some of the characters to be displayed according to the current display mode. For example, at least some of the characters to be displayed are smoothly output according to the duration m and the target number n indicated by the current display mode.

It should be understood that the character display operation may be implemented as a process of loop iterations. Specifically, if the characters in the first data packet are all displayed, the terminal device 110 may stop character display. Correspondingly, if there is a remaining character to be displayed in the first data packet, the terminal device 110 re-determines the reference display interval based on the reception interval and the number of remaining characters. Further, the terminal device 110 displays at least some of the remaining characters based on the re-determined reference display interval.

In some cases, the terminal device 110 may receive a plurality of data packets. For example, after the first data packet, the terminal device 110 receives a new data packet. Next, a process of how the terminal device 110 processes the second data packet will be further described.

In some embodiments, if the characters in the first data packet are all displayed and the second data packet is received from the remote device 130, the terminal device 110 updates the reception interval based on the second data packet, and displays the character to be displayed in the second data packet.

It should be understood that the foregoing discussion for the first data packet is applicable to the second data packet. For purposes of brevity only, the same or similar discussion is not repeated.

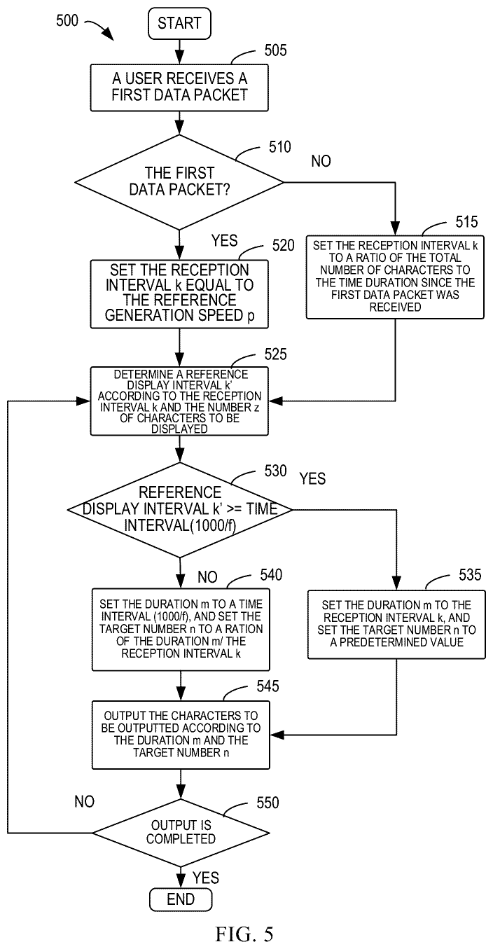

Examples of the method of information display are described above. The information display solution of the present disclosure will be described below with reference to an example. FIG. 5 shows a schematic diagram of an example process 500 of information display according to some embodiments of the present disclosure. The process 500 may be performed by the terminal device 110 or the office suite 120 in the terminal device 110. For ease of discussion, the process 500 will be described with reference to the environment 100 of FIG. 1. Process 500 may be considered an example implementation of method 300.

As shown in FIG. 5, at block 505, a user (e.g., terminal device 110) receives data (e.g., a first data packet) from a remote device 130.

At block 510, the terminal device 110 determines whether the received data is the first data packet. Herein, the first data packet refers to the first data packet received within the target time period. In some embodiments, the target time may be a predetermined time period. Alternatively, in some embodiments, the target time may be a time period in which communication is maintained with the sender of the first data packet. Alternatively, in some embodiments, the target time may be a periodic time period. It should be understood that the above example regarding the target time period is merely illustrative. In other embodiments, the target time period may be any time period for identifying the first data packet therein. The present disclosure is not limited in this respect.

In some embodiments, if the received data is not the first data packet, the process 500 proceeds to block 515. At block 515, the reception interval k is set to a ratio of the total number of characters received from the remote device 130 to the time the first data packet was received.

If it is determined at block 510 that the received data is the first data packet, the process 500 proceeds to block 520. At block 520, the reception interval k is set to the reference generation speed p, i.e., k is set equal to p.

At block 525, a reference display interval k′ is determined according to the reception interval k and the number z of characters to be displayed. In an example, k′ is set equal to k×e^{-z/c}, where c may be set to 100.

Next, at block 530, it is determined whether the reference display interval k′ is greater than or equal to the time interval (1000/f). If it is determined that the reference display interval is greater than or equal to the time interval, the process 500 proceeds to block 535.

At block 535, if the reference display interval k′ is greater than or equal to the time interval (1000/f), the duration m is set to the reception interval k, and the target number n is set to a predetermined value. For example, the predetermined value is 1, m is set equal to k, and n is set equal to 1.

If the reference display interval k′ is less than the time interval (1000/f), the process 500 proceeds to block 540. At block 540, the duration m is set to the time interval (1000/f), and the target number n is set based on the duration m and the reference display interval k′. For example, m is set equal to (1000/f), n is set equal to round(m/k′).

At block 545, the remaining character to be output is output smoothly according to the duration m and the target number n.

At block 550, it is determined whether all the characters to be output are output. If there is still a character to be output, the process returns to block 525. If the output is completed, the execution ends. If new data is received, the process 500 is restarted from block 505.

According to an embodiment of the present disclosure, the method of display information of the present disclosure may be combined with some models. Taking the dialog generation model as an example, the duration of one round of character display and the target number of characters displayed in a round of character display are adjusted by the method of the present disclosure, so that the originally unsmooth data output can be converted into a smooth data output, and the user experience and performance of the model in the service application are improved. Further, by continuously adjusting the duration of one round of character display and the target number of characters displayed in the round of character display until the characters in the received data are all displayed, the data can be continuously output smoothed.

In addition, the time interval between two refreshes of the display device is determined by the refresh parameter of the display device, and the time interval between the two refreshes is introduced into the determination of the duration and the target number, thereby adjusting the output speed of the data. Unnecessary overheads caused by rendering of the display device may be avoided.

### Example Apparatus and Device

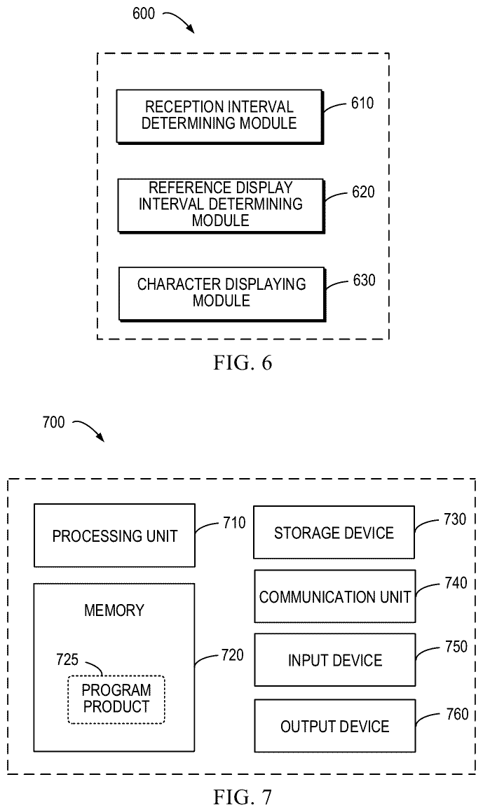

FIG. 6 shows a schematic structural block diagram of an apparatus 600 for displaying information according to some embodiments of the present disclosure. The apparatus 600 may be implemented or included in the terminal device 110. The various modules/components in the apparatus 600 may be implemented by hardware, software, firmware, or any combination thereof.

As shown, the apparatus 600 includes: a reception interval determining module 610, configured to determine a reception interval of characters based on a received first data packet comprising at least one character, the reception interval indicating a time duration consumed by receiving a single character; a reference display interval determining module 620, configured to determine a reference display interval for characters to be displayed in the first data packet based on the reception interval and the number of characters to be displayed, the reference display interval indicating a time duration consumed for displaying a single character; and a character displaying module 630, configured to display at least a portion of the characters to be displayed based on the reference display interval.

In some embodiments, the character displaying module 630 is further configured to determine a current display mode for the character to be displayed based on the reference display interval, the current display mode indicates a duration of a round of character display and a target number of characters displayed in the round of character display; and display at least a portion of the characters to be displayed according to the current display mode.

In some embodiments, the character displaying module 630 is further configured to determine a time interval between two refreshes of the display device based on a refresh parameter of a display device for character display; and determine the duration and the target number based on the reference display interval and the time interval.

In some embodiments, the character displaying module 630 is further configured to: in response to the reference display interval exceeding the time interval, set the duration to a value of the reference display interval; and setting the target number to a predetermined value.

In some embodiments, the character displaying module 630 is further configured to: in response to the reference display interval being less than the time interval, set the duration to a value of the time interval; and set the target number based on the duration and the reference display interval.

In some embodiments, the reception interval determining module 610 is further configured to: in response to the first data packet being the first data packet received within a target time period, determine the reception interval based on a reference generation speed of the characters.

In some embodiments, the reception interval determining module 610 is further configured to: in response to the first data packet not being the first data packet received within the target time period, determine the reception interval based on the total number of characters received within the target time period and the reception time of the first data packet.

In some embodiments, the target time period comprises at least one of: a predetermined time period, a time period for maintaining communication with a sender of the first data packet, or a periodic time period.

In some embodiments, the reference display interval determining module 620 is further configured to: determine the reference display interval based on the reception interval, the number of characters to be displayed in the first data packet, and an adjustment parameter. The apparatus 600 further comprises an updating module (not shown), which is configured to update the adjustment parameter based on a statistical value of the duration and a statistical value of the number of characters to be displayed.

In some embodiments, the apparatus 600 further comprises a stopping module (not shown), which is configured to: in response to all characters in the first data packet being displayed, stop the display of character.

In some embodiments, the apparatus 600 further comprises a remaining character display module (not shown), which is configured to: in response to a remaining character to be displayed existing in the first data packet, re-determine the reference display interval based on the reception interval and the number of remaining characters; and display at least a portion of the remaining character based on the re-determined reference display interval.

In some embodiments, the apparatus 600 further comprises a second data packet processing module (now shown), which is configured to: in response to receiving a second data packet, update the reception interval based on the second data packet; re-determine the reference display interval based on the updated reception interval and the number of characters to be displayed in the second data packet; and display at least a portion of the characters to be displayed in the second data packet based on the re-determined reference display interval.

In some embodiments, the first data packet is used as at least a portion of a reply to a user interaction message by a digital assistant.

FIG. 7 shows a block diagram illustrating an electronic device 700 in which one or more embodiments of the present disclosure may be implemented. It should be understood that the electronic device 700 shown in FIG. 7 is merely illustrative and should not constitute any limitation on the functionality and scope of the embodiments described herein. The electronic device 700 shown in FIG. 7 may be configured to implement the electronic device 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of electronic device 700.

Electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method of information display comprising:
determining a reception interval of characters based on a received first data packet comprising at least one character, the reception interval indicating a first time duration consumed by receiving a single character;
determining a reference display interval for characters to be displayed in the first data packet based on the reception interval and a number of the characters to be displayed, the reference display interval indicating a second time duration consumed for displaying the single character; and
displaying at least a portion of the characters to be displayed based on the reference display interval.

2. The method of claim 1, wherein displaying at least the portion of the characters to be displayed comprises:
determining a current display mode for the characters to be displayed based on the reference display interval, the current display mode indicating a duration of a round of character display and a target number of characters displayed in the round of the character display; and
displaying at least the portion of the characters to be displayed according to the current display mode.

3. The method of claim 2, wherein determining the current display mode for the characters to be displayed comprises:
determining a time interval between two refreshes of a display device based on a refresh parameter of the display device for the character display; and
determining the duration and the target number based on the reference display interval and the time interval.

4. The method of claim 3, wherein determining the duration and the target number comprises:
in response to the reference display interval exceeding the time interval, setting the duration to a value of the reference display interval; and setting the target number to a predetermined value.

5. The method of claim 3, wherein determining the duration and the target number comprises:
in response to the reference display interval being less than the time interval, setting the duration to a value of the time interval; and setting the target number based on the duration and the reference display interval.

6. The method of claim 1, wherein determining the reception interval of the characters comprises:
in response to the first data packet being the first data packet received within a target time period, determining the reception interval based on a reference generation speed of the characters; or
in response to the first data packet not being the first data packet received within the target time period, determining the reception interval based on a total number of characters received within the target time period and the reception time of the first data packet.

7. The method of claim 6, wherein the target time period comprises at least one of:
a predetermined time period,
a time period for maintaining communication with a sender of the first data packet, or
a periodic time period.

8. The method of claim 1, wherein determining the reference display interval comprises:
determining the reference display interval based on the reception interval, the number of the characters to be displayed in the first data packet, and an adjustment parameter,
the method further comprises:
updating the adjustment parameter based on a statistical value of the duration and a statistical value of the number of the characters to be displayed.

9. The method of claim 1, further comprising:
in response to all characters in the first data packet being displayed, stopping the display of character; or
in response to a remaining character to be displayed existing in the first data packet,
re-determining the reference display interval based on the reception interval and a number of the remaining characters; and
displaying at least a portion of the remaining characters based on the re-determined reference display interval.

10. The method of claim 1, further comprising:
in response to receiving a second data packet, updating the reception interval based on the second data packet;
re-determining the reference display interval based on the updated reception interval and the number of the characters to be displayed in the second data packet; and
displaying at least the portion of the characters to be displayed in the second data packet based on the re-determined reference display interval.

11. The method of claim 1, wherein the first data packet is used as at least a portion of a reply to a user interaction message by a digital assistant.

12. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
determining a reception interval of characters based on a received first data packet comprising at least one character, the reception interval indicating a first time duration consumed by receiving a single character;
determining a reference display interval for characters to be displayed in the first data packet based on the reception interval and a number of the characters to be displayed, the reference display interval indicating a second time duration consumed for displaying the single character; and
displaying at least a portion of the characters to be displayed based on the reference display interval.

13. The electronic device of claim 12, wherein displaying at least the portion of the characters to be displayed comprises:
determining a current display mode for the characters to be displayed based on the reference display interval, the current display mode indicating a duration of a round of character display and a target number of characters displayed in the round of the character display; and
displaying at least the portion of the characters to be displayed according to the current display mode.

14. The electronic device of claim 13, wherein determining the current display mode for the characters to be displayed comprises:
determining a time interval between two refreshes of the display device based on a refresh parameter of a display device for the character display; and
determining the duration and the target number based on the reference display interval and the time interval.

15. The electronic device of claim 14, wherein determining the duration and the target number comprises:
in response to the reference display interval exceeding the time interval, setting the duration to a value of the reference display interval; and setting the target number to a predetermined value.

16. The electronic device of claim 14, wherein determining the duration and the target number comprises:
in response to the reference display interval being less than the time interval, setting the duration to a value of the time interval; and setting the target number based on the duration and the reference display interval.

17. The electronic device of claim 12, wherein determining the reception interval of the characters comprises:
in response to the first data packet being the first data packet received within a target time period, determining the reception interval based on a reference generation speed of the characters; or
in response to the first data packet not being the first data packet received within the target time period, determining the reception interval based on a total number of characters received within the target time period and the reception time of the first data packet.

18. The electronic device of claim 17, wherein the target time period comprises at least one of:
a predetermined time period,
a time period for maintaining communication with a sender of the first data packet, or
a periodic time period.

19. The electronic device of claim 12, wherein determining the reference display interval comprises:
determining the reference display interval based on the reception interval, the number of the characters to be displayed in the first data packet, and an adjustment parameter,
the acts further comprise:
updating the adjustment parameter based on a statistical value of the duration and a statistical value of the number of the characters to be displayed.

20. A non-transitory computer-readable storage medium having stored thereon a computer program executable by a processor to implement a method comprising:
determining a reception interval of characters based on a received first data packet comprising at least one character, the reception interval indicating a first time duration consumed by receiving a single character;
determining a reference display interval for characters to be displayed in the first data packet based on the reception interval and a number of the characters to be displayed, the reference display interval indicating a second time duration consumed for displaying the single character; and
displaying at least a portion of the characters to be displayed based on the reference display interval.
